(19) United States
(12) Patent Application Publication
(10) Pub. No.: US 2014/0033266 A1
(43) Pub. Date: Jan. 30, 2014

(54) METHOD AND APPARATUS FOR PROVIDING CONCEALED SOFTWARE EXECUTION ENVIRONMENT BASED ON VIRTUALIZATION

(71) Applicant: Electronics and Telecommunications Research Institute, Daejeon (KR)

(72) Inventors: Young Ho KIM, Daejeon (KR); Jeong Nyeo KIM, Daejeon (KR); Jae Deok LIM, Daejeon (KR); Yun-Kyung LEE, Daejeon (KR)

(73) Assignee: Electronics and Telecommunications Research Institute, Daejeon (KR)

(21) Appl. No.: 13/947,241

(22) Filed: Jul. 22, 2013

(30) Foreign Application Priority Data
Jul. 24, 2012 (KR) 10-2012-0080668
Feb. 18, 2013 (KR) 10-2013-0016963

(51) Int. Cl. G06F 21/00

(52) U.S. Cl. CPC G06F 21/00
USPC 726/1

(57) ABSTRACT

A method and apparatus provides a concealed software execution environment based on virtualization. The method and apparatus constructs a concealed domain that is exclusively executed without being exposed to the outside using a virtualization-based domain separating technology and executes security information such as key information provided by a secure element within the concealed domain.

### RELATED APPLICATIONS(S)

This application claims the benefit of Korean Patent Application No. 0-2012-0080668, filed on Jul. 24, 2012, and Korean Patent Application No. 10-2013-0016963, filed on Feb. 18, 2013, which is hereby incorporated by references as if fully set forth herein.

### FIELD OF THE INVENTION

The present invention relates to security in a mobile terminal environment, and more particularly, to a method and apparatus for providing a concealed software execution environment based on virtualization, which constructs a concealed domain that is exclusively executed without being exposed to the outside using a virtualization-based domain separating technology and executes security information such as key information provided by a secure element within the concealed domain, thereby protecting the security information from illegal access when the security information is actually used in an application. The concealed software execution environment supports the secure element.

### BACKGROUND OF THE INVENTION

In general, a conventional mobile terminal protection technology is classified into a scheme using dedicated hardware and a scheme using software such as a malicious code search. The scheme using hardware has stability since it manages important security information such as an encryption algorithm and key information within a secure element that is a separate closed physical device. However, the scheme using hardware is applied in a very restrictive manner because of limited resources of the physical device. In addition, in case that data within the secure element is used in a terminal, the illegal leakage of information may occur since the data is exposed to threats such as hacking and a malicious code.

The security information such as an encryption key provided by the secure element is safely protected within the secure element. However, it has a problem that the security information is exposed to an application processor and a memory in case that the security information is used in an application of a terminal. Because of a structure of a recent mobile terminal implemented with an open operating environment, the mobile terminal is exposed to the threats such as the malicious code and hacking. As a result, sensitive information provided by the secure element is also vulnerable to the leakage.

To protect important information in the conventional mobile terminal, a secure element, which is separate from an application processor of the terminal, is used. However, even though information is protected by the secure element, if an application program of the terminal uses the information, it still has a problem that the information resides in a memory and an application processor of the terminal.

Therefore, a method of providing security and stability of primary data certainly required in a mobile office or a financial service is in desperate need.

### SUMMARY OF THE INVENTION

An embodiment of the present invention is to provide a method of safely protecting security information and computation by providing a separate concealed execution environment even when it is used as an execution environment of a terminal for important security information protected within a secure element to thereby solve a problem occurring in a current terminal environment in which the security element is directly accessed in an open operating environment.

Another embodiment of the present invention is to provide an apparatus and method capable of implementing a major security computation and service with an application processor having high performance, based on security provided by a secure element.

Still another embodiment of the present invention is to provide a method and apparatus for providing a concealed software execution environment based on virtualization, which constructs a concealed domain that is exclusively executed without being exposed to the outside using a virtualization-based domain separating technology and executes security information such as key information provided by a secure element within the concealed domain, thereby protecting the security information from illegal access when the security information is actually used in an application, the concealed software execution environment supporting the secure element.

In accordance with an aspect of the present invention, there is provided an apparatus for providing a virtualization-based concealed software execution environment in a mobile terminal, the apparatus including: an open operating environment unit; a concealed operating environment unit configured to process a security service request as being linked with a secure element unit that stores security information when the security service request is received from the open operating environment unit that processes a general service, and provide a result of processing the security service request to the open operating environment unit; and the secure element unit configured to store the security information required in executing the security service, execute a security service using the security information when the security service request is transferred from the concealed operating environment unit, and provide a result of executing the security service to the concealed operating environment unit.

The concealed operating environment unit may establish a session with the secure element unit, transfer the security service request to the secure element unit, and transmit the result of executing the security service provided from the secure element unit to the open operating environment unit.

The concealed operating environment unit may process the security service without being linked with the secure element unit in case that the security service does not directly require the security information, and provide a result of processing the security service.

A domain of the concealed operating environment unit and a domain of the open operating environment may be separate from each other based on virtualization.

The concealed operating environment unit may include a security service request managing sector configured to receive the security service request from the open operating environment unit, a security service executing sector configured to execute the security service, a session managing sector configured to establish a session with the secure element unit in case that the security service requires the security information stored in the secure element unit, a secure element managing sector configured to search the secure element unit to establish the session with the secure element unit, and a command transferring sector configured to transfer the security service request to the secure element unit where the session is established.

The open operating environment unit may include an application program configured to manage an application that is executed in the mobile terminal, and a security service requesting sector configured to transfer the security service request to the concealed operating environment unit.

The secure element unit may include a command processing sector configured to receive the security service request from the concealed operating environment unit, and a secure element executing sector configured to execute the security service using the security information according to the security service request.

In accordance with another aspect of the present invention, there is provided a method of providing a virtualization-based concealed software execution environment in a mobile terminal, the method including: receiving, by a concealed software execution environment unit, a security service request from an open operating environment unit whose domain is separate from that of the concealed software execution environment unit; processing, by the concealed software execution environment unit, the security service request as being linked with a secure element unit that stores security information of the mobile terminal; and providing, by the concealed software execution environment unit, a result of executing a security service to the open operating environment unit.

Processing the security service request may include transferring, by the concealed software execution environment unit, the security service request to the secure element unit, executing, by the secure element unit, the security service using the security information, and receiving, by the concealed software execution environment unit, a result of executing the security service from the secure element unit.

Processing the security service request may include executing, by the concealed operating environment unit, the security service in case that the security service does not directly require the security information, and providing a result of executing the security service.

The present invention has an advantage of safely protecting security information and computation by providing a separate concealed execution environment even when it is used as an execution environment of a terminal for important security information protected within a secure element to thereby solve a problem occurring in a current terminal environment in which the security element is directly accessed in an open operating environment.

The present invention also has another advantage of providing various security functions without limitations in the performance through a concealed operating environment based on virtualization to overcome limitations due to a limited computing environment of a secure element.

The present invention can be used to increase the stability of a terminal and protect internal data in a field of a broadcasting and in-vehicle terminal platform as well as a mobile terminal. In particular, it has an advantage of safely protecting the terminal platform from an illegal attack and blocking a software attack in a security field for protecting data and software execution in a mobile terminal environment.

### BRIEF DESCRIPTION OF THE DRAWINGS

The above and other objects and features of the present invention will become apparent from the following description of embodiments given in conjunction with the accompanying drawings, in which:

FIG. 1 is a hardware configuration of a mobile terminal in accordance with an embodiment of the present invention;

FIG. 2 illustrates a general model to which a secure element in accordance with an embodiment of the present invention is applied;

FIG. 3 illustrates a model to which a concealed software execution environment in accordance with an embodiment of the present invention is applied;

FIG. 4 illustrates major components of a concealed software execution environment in accordance with an embodiment of the present invention; and

FIG. 5 is a flowchart illustrating processes of executing a concealed software execution environment in accordance with an embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Hereinafter, embodiments of the present invention will be described in detail with reference to the accompanying drawings so that they can be readily implemented by those skilled in the art.

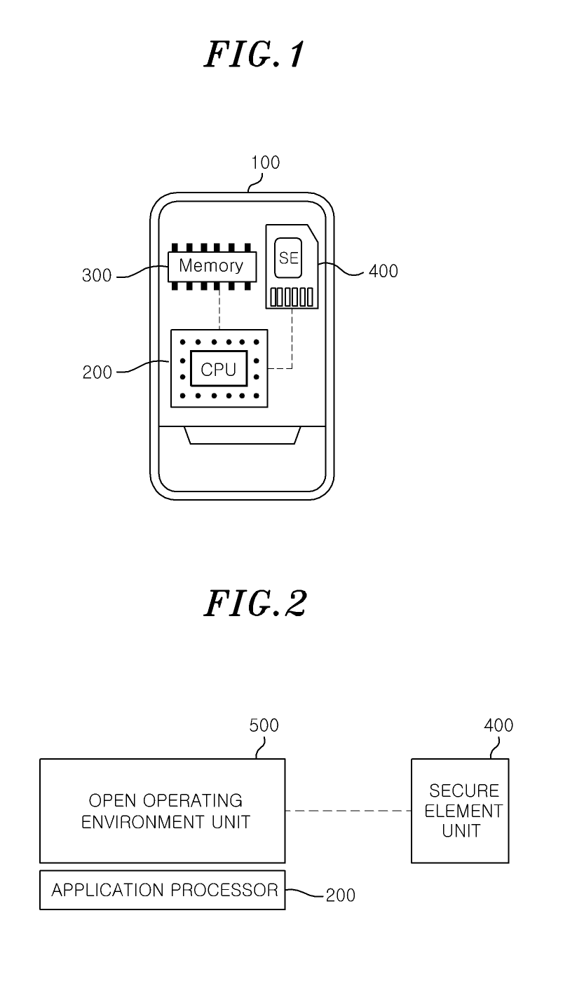

FIG. 1 is a configuration of a mobile terminal 100 in accordance with an embodiment of the present invention.

Referring to FIG. 1, a concealed software execution environment supporting a secure element in accordance with an embodiment of the present invention includes an application processor 200, a memory 300, and a secure element unit 400.

A technology for the secure element unit 400 includes a universal integrated chip (IC) card (UICC) and a micro secure digital (SD) card. An embodiment of the present invention is not limited to a certain technology for the secure element unit 400, and may include any method.

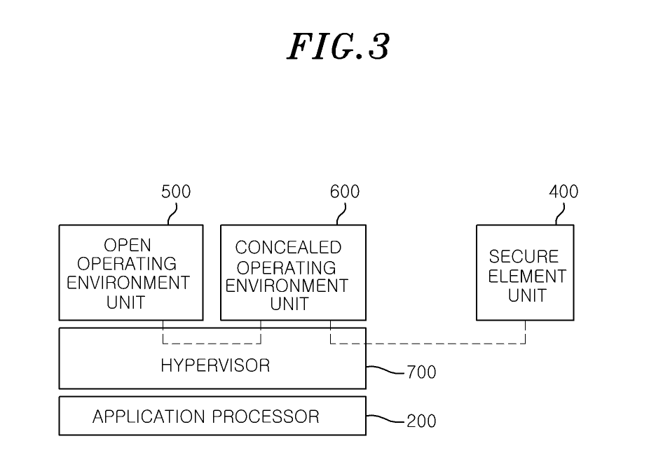

FIG. 2 illustrates a software configuration of a general mobile terminal.

Referring to FIG. 2, software running on the application processor 200 constitutes an open operating environment unit 500. Information requiring high security, such as a user authentication module, is processed in the secure element unit 400 that is separate hardware.

A data transferring structure shows that an application program being executed in the open operating environment unit 500 directly requests or receives data from the secure element unit 400. As a result, since the open operating environment unit 500, which has high possibility of being exposed to security threats, directly use the data protected by the secure element unit 400, it may cause an illegal data leakage. At this point, the data protected by the secure element unit 400 includes security information such as an encryption key or algorithm, and may include all information protected from external access. In particular, the security information may include user authentication information and private key information used in an open key based algorithm.

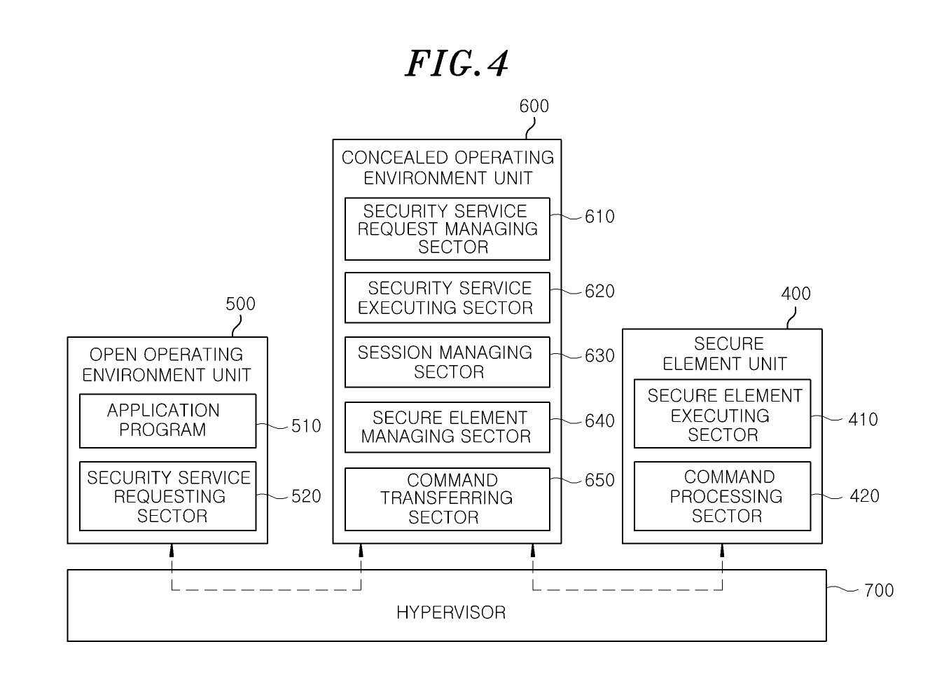

FIG. 3 illustrates a configuration of a mobile terminal in accordance with an embodiment of the present invention.

Referring to FIG. 3, the mobile terminal includes two independent execution regions that include an open operating environment unit 500 and a concealed operating environment unit 600, which are divided using a hypervisor 700 on an application processor 200. A secure element unit 400 is configured to exchange information only in the concealed operating environment unit 600.

Therefore, the open operating environment unit 500 in which a terminal application program is executed can be provided with a security function from the secure element unit 400 only through an interface provided by the concealed operating environment unit 600.

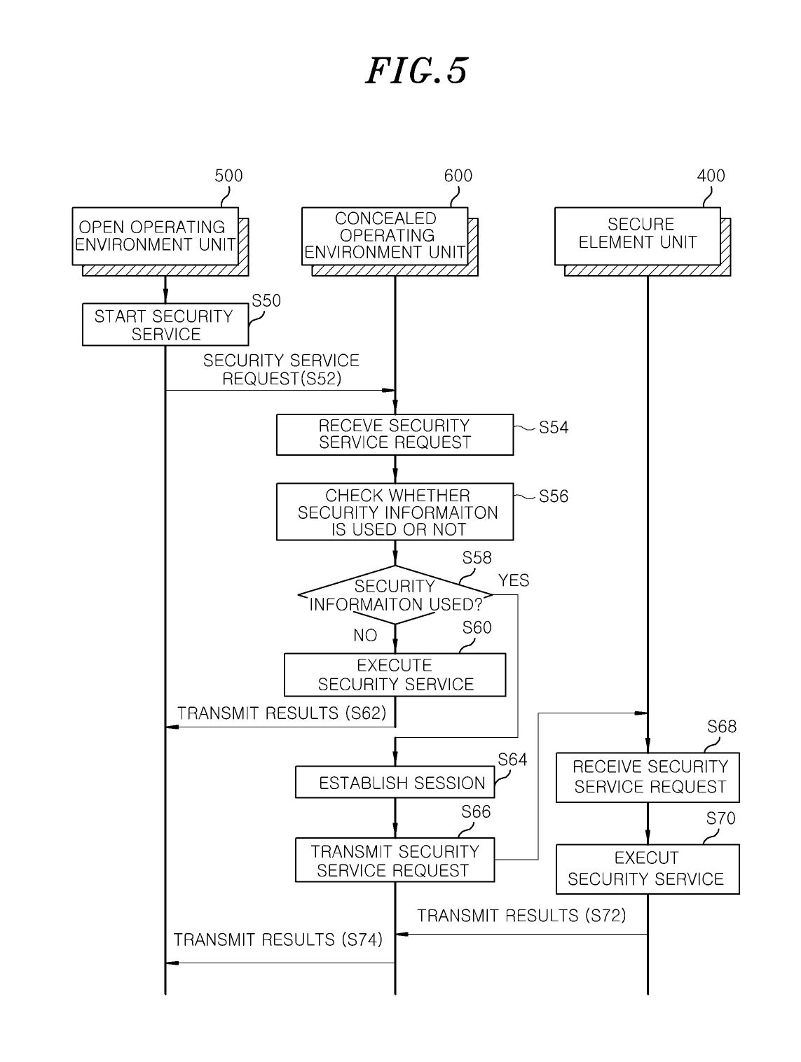

FIG. 4 illustrates internal components of the open operating environment unit 500, the concealed operating environment unit 600, and the secure element unit 400, which constitute a virtualization-based concealed software execution environment providing apparatus in accordance with an embodiment of the present invention.

The internal components of the open operating environment unit 500, the concealed operating environment unit 600, and the secure element 400 will be described in detail with reference to FIG. 4.

First of all, the open operating environment unit 500 includes an application program 510 and a security service requesting sector 520 for transferring a security function and service requested by the application program sector 510 to the concealed operating environment unit 600 and receiving a result value from the concealed operating environment unit 600.

The concealed operating environment unit 600 includes a security service request managing sector 610 for processing a security function and service request from the open operating environment unit 500 and a security service executing sector 620 for executing the requested security service. In addition, the concealed operating environment unit 600 includes a secure element managing sector 640 for searching and managing the secure element unit 400 that supports a session establishment with the secure element unit 400 in case that the requested security service uses a security element, a session managing sector 630 for managing a logical channel with the secure element unit 400, and a command transferring sector 650 for directly transferring a command to the secure element unit 400.

The secure element unit 400 includes a command processing sector 420 for receiving a request for an internal function of a secure element from the concealed operating environment unit 600 and a secure element executing sector 410 for performing the internal function of the secure element.

FIG. 5 is a flowchart illustrating a virtualization-based concealed software execution environment providing method for supporting a secure element in accordance with an embodiment of the present invention. Hereinafter, the embodiment of the present invention will be described with reference to FIGS. 3 to 5.

The application program 510 of the open operating environment unit 500 of the mobile terminal starts a security function and service request through an interface with the security service requesting sector 520 at step S50.

The security service requesting sector 520 transfers the security service request to the security service request managing sector 610 of the concealed operating environment unit 600 through an interface between the open operating environment unit 500 and the concealed operating environment unit 600 at step S52.

As described above, in case that the security service request is transferred from the open operating environment unit 500 to the concealed operating environment unit 600, the security service request managing sector 610 of the operating environment unit 600 receives the security service request at step S54.

At this time, the security service request received by the security service request managing sector 610 is provided to the security service executing sector 620 through an internal interface.

After that, the security service executing sector 620 receives the security service request from the security service request managing sector 610 and checks whether or not the corresponding security service is a security service that uses security information being protected by the secure element unit 400 at step S56.

If it is determined that the corresponding security service is a security service that does not use the security information being protected by the secure element unit 400 at step S58, the security service executing sector 620 performs the security service without being linked with the secure element unit 400 at step S60, and transmits results to the open operating environment unit 500 at step S62.

On the other hand, if it is determined that the corresponding security service is the security service that uses the security information being protected by the secure element unit 400 at step S58, the security service executing sector 620 checks whether or not a session with the secure element unit 400 exists in advance to execute the corresponding security service, through an interface with the session managing sector 630, and establishes the session at step S64.

At this time, if the session with the secure element unit 400 for executing the corresponding security service does not exist, the session managing sector 630 establishes the session with the secure element unit 400 to execute the corresponding security service. To establish the session with the secure element unit 400, it is required to search the secure element unit 400 employed in the mobile terminal. In case that there is a request from the session managing sector 630, the secure element managing sector 640 searches the secure element unit 400 in the mobile terminal and provides corresponding information to the session managing sector 630.

As described above, when the session is established between the concealed operating environment unit 600 and the secure element unit 400, the command transferring sector 650 transfers the security service request to the secure element unit 400 using the interface between the concealed operating environment unit 600 and the secure element unit 400 at step S66.

The command processing sector 420 of the secure element unit 400 receives the security service request from the command transferring sector 650 at step S68, and the command processing sector 420 transfers the security service request to the secure element executing sector 410 through an internal interface.

Subsequently, at step S70, the secure element executing sector 410 executes the corresponding security service using the security information being protected by the secure element unit 400 according to the security service request transferred from the command processing sector 420.

If the execution of the security service is completed in the secure element executing sector 410, at step S72, a result value of the security service is transmitted to the concealed operating environment unit 600 through a reverse path of the path through which the security service request is transmitted. The result value is transferred to the application program 510 of the open operating environment unit 500, which has requested the security service, through the concealed operating environment unit 600 at step S74.

As described above, in accordance with the embodiments of the present invention, in providing a concealed software execution environment supporting a secure element, it is possible to protect security information, which is provided by the secure element, from illegal access when the security information is actually used in an application by constructing a domain that is exclusively executed without being exposed to the outside using a virtualization-based domain separating technology and executing within the concealed domain the security information such as key information provided by the secure element.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for providing a virtualization-based concealed software execution environment in a mobile terminal, the apparatus comprising:
an open operating environment unit;
a concealed operating environment unit configured to process a security service request as being linked with a secure element unit that stores security information when the security service request is received from the open operating environment unit that processes a general service, and provide a result of processing the security service request to the open operating environment unit; and
the secure element unit configured to store the security information required in executing the security service, execute a security service using the security information when the security service request is transferred from the concealed operating environment unit, and provide a result of executing the security service to the concealed operating environment unit.

2. The apparatus of claim 1, wherein the concealed operating environment unit is configured to establish a session with the secure element unit, transfer the security service request to the secure element unit, and transmit the result of executing the security service provided from the secure element unit to the open operating environment unit.

3. The apparatus of claim 1, wherein the concealed operating environment unit is configured to process the security service without being linked with the secure element unit in case that the security service does not directly require the security information, and provide a result of processing the security service.

4. The apparatus of claim 1, wherein a domain of the concealed operating environment unit and a domain of the open operating environment are separate from each other based on virtualization.

5. The apparatus of claim 1, wherein the concealed operating environment unit comprises:
a security service request managing sector configured to receive the security service request from the open operating environment unit;
a security service executing sector configured to execute the security service;
a session managing sector configured to establish a session with the secure element unit in case that the security service requires the security information stored in the secure element unit;
a secure element managing sector configured to search the secure element unit to establish the session with the secure element unit; and
a command transferring sector configured to transfer the security service request to the secure element unit where the session is established.

6. The apparatus of claim 1, wherein the open operating environment unit comprises:
an application program configured to manage an application that is executed in the mobile terminal; and
a security service requesting sector configured to transfer the security service request to the concealed operating environment unit.

7. The apparatus of claim 1, wherein the secure element unit comprises:
a command processing sector configured to receive the security service request from the concealed operating environment unit; and
a secure element executing sector configured to execute the security service using the security information according to the security service request.

8. A method of providing a virtualization-based concealed software execution environment in a mobile terminal, the method comprising:
receiving, by a concealed software execution environment unit, a security service request from an open operating environment unit whose domain is separate from that of the concealed software execution environment unit;
processing, by the concealed software execution environment unit, the security service request as being linked with a secure element unit that stores security information of the mobile terminal; and
providing, by the concealed software execution environment unit, a result of executing a security service to the open operating environment unit.

9. The method of claim 8, wherein processing the security service request comprises:
transferring, by the concealed software execution environment unit, the security service request to the secure element unit;
executing, by the secure element unit, the security service using the security information; and
receiving, by the concealed software execution environment unit, a result of executing the security service from the secure element unit.

10. The method of claim 8, wherein processing the security service request comprises:
executing, by the concealed operating environment unit, the security service in case that the security service does not directly require the security information; and
providing a result of executing the security service.

11. The method of claim 8, wherein a domain of the concealed operating environment unit and the domain of the open operating environment are separate from each other based on virtualization.
